(19) United States
(12) Patent Application Publication
(10) Pub. No.: US 2010/0156403 A1
(43) Pub. Date: Jun. 24, 2010

(54) METHOD AND DEVICE FOR DETERMINING THE LOCATION OF THE STICKING POINT OF A ROD MADE OF MAGNETORESTRICTIVE MATERIAL LOCATED IN A WELL

(75) Inventors: Jean-Pierre Martin, Le Vaudreuil (FR); Phillippe Broun, Saint Egreve (FR); Jean-Louis Coulomb, Saint-Ismier (FR); Jean-Paul Bongiraud, Le Villard (FR); Vincent Bongiraud, Le Villard (FR)

Correspondence Address: SCHWEGMAN, LUNDBERG & WOESSNER, P.A., P.O. BOX 2938, MINNEAPOLIS, MN, 55402, US

(73) Assignee: GEO ENERGY, Le Vaudreuil (FR)

(21) Appl. No.: 12/364,240

(22) Filed: Feb. 2, 2009

Related U.S. Application Data
(63) Continuation of application No. 12/140,685, filed on Jun. 17, 2008, now abandoned.
Application No. 12/140,685 is a continuation of application No. PCT/FR2006/002775, filed on Dec. 19, 2006.

(30) Foreign Application Priority Data
Dec. 21, 2005 (FR) 0513343

(51) Int. Cl. G01N 27/72

(52) U.S. Cl. 324/221

(57) ABSTRACT

The present invention relates to methods for determining the location of the sticking point Pc of a hollow rod or pipe 1 located in a shaft 30 subjected to the Earth's magnetic field, the point Pc being located in a part 3 defined between two points H and B of the pipe. The method according to the invention is essentially characterized in that it consists in continuously performing via the inside 2 of pipe 1, a first measurement of the magnetic field inside the part 3 of the pipe, by indexing it relative to the distance to one of the two points H and B, in applying a mechanical stress to the pipe at one of the two points H, B, in performing a second measurement of the Earth's magnetic field inside the part 3 of the pipe, by indexing it relative to the distance to one of the two points H and B, and in comparing the results R₁-R₂ of the two measurements in order to determine the location of the point Pc. The invention also relates to a device for implementing this method. Advantageous application to determining the location of a sticking point Pc of a string of drill pipes located in an oil well.

The present invention concerns the methods and devices for determining the location of the sticking point of a hollow rod in a magnetostrictive material located in a well or the like, subjected to the earth's magnetic field, finding a particularly advantageous application in determining the location of the sticking point of a string of rods used to drill an oil well.

The present invention also concerns, by way of application, methods for creating a neutral point at a particular site of a string of boring rods in relation to the sticking point.

The present invention also concerns devices allowing these methods to be put into effect.

As is known, to drill an oil well, for example, one uses a hollow boring rod made up of an assemblage of pieces of successive rods, known as a “string of rods”, whose penetrating end contains means of boring. These boring devices are well known in themselves, as is their use, and they shall not be further described here.

More particularly, in the oil well field, these strings of rods may reach very long lengths, several thousands of meters, and they are sometimes subjected to seizing, which prevents further drilling of the well or their return to the surface. Such seizing may occur, for example, after encountering an obstacle, a landslide, etc.

Granted that such a seizing generally occurs at a great depth, it is obviously impossible to abandon the entire string of rods and boring bits, as well as the portion of well already achieved.

It is thus absolutely essential to unwedge the string of rods to recover the totality of the drilling elements and continue drilling the well.

For this, various techniques have been created and can be carried out, as long as the location of the jam has been determined with a relatively good precision.

In the case of drilling an oil well by means of a string of boring rods screwed end to end, it is required to determine the ends of the pieces of rod situated on either side of the jam.

Many methods have already been used to determine the position of the sticking point, notably the one described in GB-A-2 158 245. The method described in this document requires a stage of magnetic excitation of the string of rods and two supplemental stages involving the taking of two measurements before and after having subjected the string of rods to a mechanical stress, then a comparison of the results of the two measurements to determine the sticking point.

This prior art is relatively long and sometimes even hard to implement.

Thus, the purpose of the present invention is to implement a method to determine the location of the sticking point of a hollow rod in a magnetostrictive material located in a well or the like, where the earth's magnetic field is prevailing, making it possible to mitigate a large portion of the drawbacks mentioned above for the techniques used up to now, that is, a method which allows one to determine with precision the location of this sticking point must more rapidly and easily than with the methods of the prior art.

More precisely, the purpose of the present invention is a method to determine the location of the sticking point of a hollow rod or the like in a magnetostrictive material located in a conduit subjected to the earth's magnetic field, said sticking point being located between a first and a second point belonging to said hollow rod, characterized in that it comprises the following consecutive stages involving:
continuously making, via the inside of the hollow rod and between the two aforesaid points, a first measurement of the value of the magnetic field inside the hollow rod having been magnetized by the earth's magnetic field, this first measurement being done by indexing it with respect to the distance from one of said first and second points,
applying a mechanical stress to said hollow rod at one of said first and second points,
continuously making, via the inside of the hollow rod and between the two aforesaid points, a second measurement of the value of the magnetic field inside the hollow rod, this second measurement being done by indexing it with respect to the distance from one of said first and second points, and
comparing the results of the first and second measurements to determine the location of the sticking point of the hollow rod between said first and second points, with respect to one of these two points.

Another purpose of the present invention is a device for implementing the above defined method, characterized in that it contains:
a casing of nonmagnetic material,
means of moving the casing inside the hollow rod,
means of indexing the position of the casing with respect to the hollow rod when it is moving between said first and second points, and
means, mounted in cooperation with the casing, to measure the magnetic field at each point of the hollow rod, and
means for processing the results of the measurements provided by the means mounted in cooperation with the casing to measure the magnetic field at each point of the hollow rod, so as to determine said sticking point.

Other characteristics and advantages of the present invention will appear in the course of the following description, given with respect to the drawings enclosed for illustrative and not limitative reasons, in which:

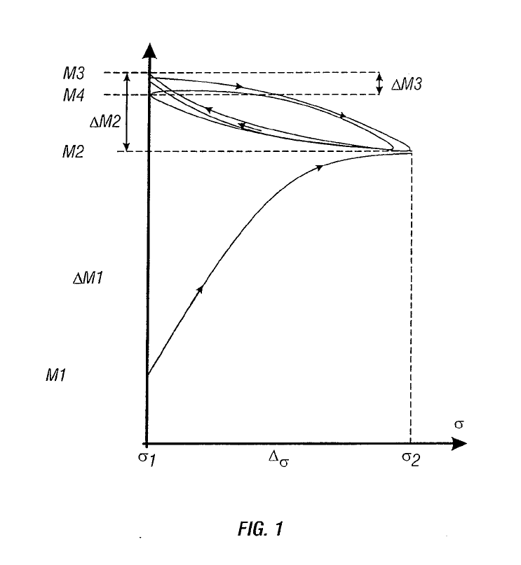

FIG. 1 shows a curve representing the variations in the magnetization of a magnetostrictive material as a function of the strength of mechanical forces applied to this material, and

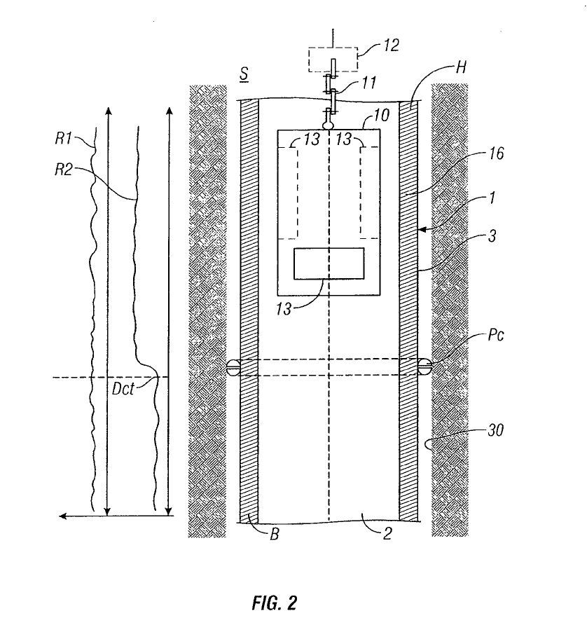

FIG. 2 shows, in very schematic fashion, one embodiment of the device for implementing the method according to the invention, being introduced into a hollow rod located in a well, associated with two curves illustrating an example of results of measurements taken in the context of the implementation of the method.

It should be noted, first of all, that the figures represent only one embodiment of the object of the invention, but there can be other embodiments corresponding to the specification of this invention.

The present invention concerns a method to determine the location of the sticking point Pc of a hollow rod 1 or the like in a magnetostrictive material located in a conduit 30, when this sticking point Pc is located between two first H and second B points belonging to the hollow rod 1.

As mentioned in the preamble of the present specification, this method finds a particularly advantage application in determining the position of a sticking point Pc, in an oil well, of a string of hollow boring rods.

Thus, one example of the implementing of the method of the invention is specified hereafter in the context of this application. Thus, the first point H is defined as being the top point of the string of rods, at the surface of the boring well, and the second point B as the end point of the string of rods at the bottom of the well, given that the length of the string of rods in the well is always perfectly known and defined from the top point H.

Referring to FIG. 2, it is assumed that a hollow rod or string of rods 1 of a magnetostrictive material descends into an oil well 30 from the summit S of this well down to a certain drilling depth, given that this depth may reach to thousands of meters and that the earth's magnetic field is prevailing in this well. This rod 1, especially in the field of oil well drilling, is made up of a string of rods, for example, whose end H emerging from the summit S of the well 30 can be manipulated by the drill operator. Its opposite end B is located at the bottom of the well and can support a boring bit, well known in itself, and thus being deliberately omitted from the figure.

It is also assumed that the rod 1 is stuck at a point of the well, for example, the point Pc, for various reasons which the practitioner in the field of oil wells is quite familiar with, and which will not be explained here because they are not part of the scope of the invention.

This being stipulated, it is necessary, for example, as explained in the preamble of the present specification or possibly for other reasons, to determine with precision the position of the sticking point Pc of the rod 1 in the well, it being understood that, without this phase of the procedure being necessary, this position has been previously determined in approximate fashion and this sticking point Pc is contained in the portion of rod 3 defined between the two first and second points H and B.

Referring to FIG. 2, the method involves the following consecutive stages involving continuously making, via the inside 2 of the hollow rod or string of rods 1, a first measurement of the value of the magnetic field along the inside of the portion 3 of hollow rod having been magnetized by the earth's magnetic field, this first measurement being done by indexing it with respect to the distance from one of the first and second points, applying a mechanical stress to the hollow rod or to the string of rods at one of the first and second points H, B, continuously making, via the inside 2 of the hollow rod 1, a second measurement of the magnetic field in the portion 3 of hollow rod, this second measurement being also done by indexing it with respect to the distance from one of the first and second points, and finally comparing the results R1, R2 of the first and second measurements to determine the location of the sticking point Pc of the hollow rod between the first and second points, with respect to one of these two points, the difference between the values of the results R1 and R2 being directly tied to a variation, positive or negative, in the magnetization of the material making up the hollow rod under the action of the mechanical stress.

It is obvious that, in the case of an oil well as mentioned above, the measurements will be indexed relative to the first point H, which is at the summit S of the well 30.

But, for other applications, for example, in horizontal or other boring, it will be possible to index the measurements relative to the second point B.

As mentioned before, the method consists in applying, in one of its stages, a mechanical stress to the hollow rod at one of the first and second points H, B. It is likewise evident that, in the case of an oil well, this stress will be applied to the point H at the summit S of the well.

In the context of the implementing of the method of the invention, this mechanical stress can be effectuated by one of the following two methods: either application of the mechanical stress prior to the stage of making the second continuous measurement of the value of the magnetic field in the portion 3 of rod and cancellation of the stress before taking this second measurement, or application of the mechanical stress prior to the stage of making the second continuous measurement of the value of the magnetic field in the portion 3 of rod and maintaining of this stress while taking this second measurement.

As to the nature of the mechanical stress, it is one of the following mechanical forces: a torsion, a traction, a compression, a combination of a torsion and a traction, a combination of a torsion and a compression.

The present invention also concerns a device for implementing the above defined method.

This device comprises, as schematically illustrated in FIG. 2, a casing 10 of a nonmagnetic material, for example, a composite material or a material known by the name of epoxy, means 11 of moving the casing 10 by translation inside 2 the hollow rod 1, means 12 of indexing the position of the casing 10 with respect to the hollow rod 1 when it is moving between the first and second points H, B, means 13 mounted in cooperation with the casing 10 to measure the magnetic field at each point of the hollow rod 1, and means for processing the results of the measurements provided by the means 13 mounted in cooperation with the casing 10 to measure the magnetic field at each point of the hollow rod 1, so as to determine the sticking point Pc.

The means 11 for moving the casing 10 by translation are generally comprised of a cable whose one end is fixed to the casing and the other end is connected at the surface of the well to a winch which can be controlled to unwind or wind up the cable to produce a descending or an ascending of the casing in the string of rods. These means, furthermore, let one learn the spatial position of the casing in the string of rods in relation to the summit S of the well, simply by measuring the length of cable unwound or wound up. These means for measuring the length of cable in fact constitute the aforesaid means 12 for indexing the position of the casing relative to the hollow rod 1. These means 11, 12 are well known in themselves and shall not be described at greater length here.

As for the means 13 mounted in cooperation with the casing 10 to measure the magnetic field at each point of the hollow rod 1, these are generally comprised of at least one magnetometer, for example, a Hall-effect type. Such a magnetometer is well known in itself and shall not be described at greater length here. For example, it can be comprised of one of the following sensors: GMR sensor of brand name HONEYWELL series 1021 or 1022, GMR sensor of brand NVE Corporation series AAH002-02 or AAH004-00.

To increase the sensitivity of the measurements, the device has a plurality of magnetometers distributed all around the casing so that the set of these magnetometers can analyze the entire periphery of the internal wall of the rods. The applicant has constructed such a device having a casing with several sensors, which has yielded good results.

As mentioned above, the device contains several magnetometers which can perform an absolute measurement of the magnetic field in the rod. These magnetometers can be of scalar type (measurement of the modulus of the magnetic field) or vectorial type (measurement of the magnetic field components along one, two or three axes), each one having one or more measurement axes. They are arranged on the outer surface of the casing 10 in the region of the magnetic detection head.

According to the device illustrated in FIG. 2, each of the magnetometers measures the radial component and/or the orthoradial component and/or the longitudinal component of the magnetization of the rod.

The implementing of several magnetometers has the following advantages, in particular: calculation of the measurements performed by the different magnetometers (for example, sum of the magnetic components, sum of the magnetic field moduli) makes it possible to improve the signal/noise ratio, and the detection of the magnetic field is not affected by the position of the device in the boring rod.

Moreover, it is stipulated that the device according to the invention can advantageously also contain memory means of any type, for example, a plotter on paper or the like, or a video screen with image persistence, and means of transmitting to these memory means the signal representing the result of the measurements, obtained as explained above, so as to save all the results in memory. These latter means are likewise well known in themselves by the practitioner and present no difficulty to implement. Thus, neither shall they be described more fully here, for the sake of simplifying the present specification.

It is emphasized that the means described above, such as the memories, a power pack, etc., can be situated in the casing 10, or on the surface at the summit S of the well 30. When they are in the casing 10, they can be connected to a processing unit or the like, of the microprocessor kind, located at the surface of the well, by a shielded electrical conductor, for example, one consisting of a connection bus.

It is also stipulated that when one uses the term “continuous measurement” in the present specification this basically covers the following two notions:
a first process in which the measurements are taken without interruption by one (or more) magnetometer, which is moved without halting inside the hollow rod, between the two points B, H. This first process can be of interest, because it is rapid.
a second process in which the measurements are taken by one (or more) magnetometer which is moved in steps, with a halt during each step to take a measurement, provided that the length of the step is relatively short so that all of the measurements taken are sufficiently dense and thus can be assimilated, for example by extrapolation, to a continuous measurement. This second process can be of interest, since it can eliminate certain interference.

The implementing of the method of the invention shall be explained as follows:

First of all, remember that when a rod for a drill string of magnetostrictive material having a magnetization induced, for example, by the earth's magnetic field is subjected to a mechanical stress, its remanent magnetization varies as shown by the curve in FIG. 1.

When first placed under mechanical stress (the stress increases from σ1 to σ2, or an increase of Δσ), the magnetization of the material changes from M1 to M2, that is, it undergoes a variation ΔM1.

When the mechanical stress is canceled, going from σ2 to σ1, the magnetization of the material undergoes a supplemental variation ΔM2.

Consequently, if one subjects a string of boring rods in a magnetostrictive material to a mechanical stress that increases from σ1 to σ2, and if the mechanical stress is then canceled, the remanent magnetization of the material has undergone a total variation of ΔMT=ΔM1+ΔM2.

Starting with this principle, the implementing of the method of the invention can be understood as follows:

When one detects a seizing of a hollow rod in a drilling well, one lowers the casing 10 from the first point H to the second point B, this latter one being situated after the presumed sticking point. If the location of this sticking point is not approximately known, the casing 10 is lowered to the bottom end of the string of rods.

During this movement, one measures continuously the value of the magnetic field inside the string of rods, indexing the values obtained relative to the rods. These values yield, for example, a curve such as the one shown at R1 in FIG. 2 as a function of the distance between the points H and B.

When the casing has arrived at the level of point B, the drilling operator exerts on the string of rods a mechanical stress with an amplitude, making reference to FIG. 2, of Δσ=σ2−σ1, then possibly cancels it. The mechanical stress having been canceled, the casing 10 is moved from point B to point H and, at the same time, the continuous measurement is taken for the value of the magnetic field inside the string of rods after the mechanical stress has been applied, always indexing the values obtained with respect to the rods. These values yield, for example, a curve like that shown at R2 in FIG. 2 as a function of the distance between point B and point H.

On the curve R2, one finds a discontinuity Dct. This discontinuity in the value of the magnetic field measured inside the string of rods is situated in the location of the sticking point of the string of rods, which is explained as follows: when the drilling operator applied the mechanical stress to point H of the string of rods, this mechanical stress was transmitted to the points located between point H and point Pc, and of course not between point Pc and point B, because the rod is stuck at point Pc. Under these conditions, only the portion of the rod between point H and point Pc has undergone a variation in its magnetization.

From the above description, it is clear that the method of the invention is able to determine very quickly and easily the location in a well of a sticking point of a string of rods situated in this well.

It is stipulated that the implementation of the method has been described above starting with the movement of the casing 10 from the point H to the point b, but the opposite is possible.

The method described above can be easily implemented by means of the device of the invention as described above and schematically illustrated in FIG. 2, whose functioning it is not necessary to describe more fully.

The method described above lets one determine very easily the sticking point of a string of well drilling rods, especially for an oil well.

According to one additional characteristic of the invention, basically by way of application in the field of oil well drilling, the method makes it possible to create a so called “neutral” point in a particular location of a stuck string of rods.

In fact, as is known, a string of oil drilling rods is made up from a plurality of rods joined to each other by screwing. The portion of the joint which is common to the two rods assembled consecutively is comprised of the end of one rod having a female screw and another end of the other rod having a male screw. The portion of the string bounded by the two ends screwed together is known as the “collar”.

When a string gets stuck, it is necessary to determine the first collar located just above the sticking point Pc, so as to unscrew only this first collar, and not one of the other collars located above the sticking point, in order to recover the entire first portion of the string of rods situated above the first collar, the second portion of the string of rods situated below this first collar being abandoned and/or handled differently.

To carry out this maneuver of unscrewing, a technique is known, essentially consisting in first determining the location of the first collar and then applying to the summit S of the string of rods emerging from the well a traction force which is basically equal to the weight of the first portion of the string of rods, so that this first collar is not subjected to any force, other than a force reduced to the minimum, and defining then what technicians call a “neutral point” of the string of rods.

The technique then consists in exerting a shock or applying a blow to this first collar, for example, by means of an explosive charge, which will allow it to be unscrewed, in the same way that a hammer blow against two parts screwed together is known to facilitate their unscrewing.

According to characteristics in addition to those defined above, the method of the invention then consists of, in succession:
estimating the weight of the first portion of the rod string as a function of the weight and the length of each rod making up this first portion of the string of rods,
making a continuous third measurement of the value of the magnetic field via the inside 2 of the string of hollow rods 1 magnetized by the earth's magnetic field and on a portion of the string that includes at least the sticking point Pc,
applying to the summit S of the string of rods emerging from the well a traction force essentially equal to the estimated weight of the first portion of the string of rods,
making a continuous fourth measurement of the value of the magnetic field via the inside 2 of the string of hollow rods 1 and on said portion of the string, then
comparing the results of the third and fourth measurement to determine, in relation to the sticking point, the place in the string of rods where the value of the magnetic field varies, and verifying whether this place is situated above the sticking point and at a distance less than the length of a rod making up the string of rods.

If not, it will be necessary to adjust the traction force in dependence on the result of the comparison as defined above and possibly repeating the fourth measurements as defined above, especially to verify that the neutral point is situated in the location of the first collar, as defined above.

1. Method to determine the location of the sticking point (Pc) of a hollow rod or the like (1) in a magnetostrictive material located in a conduit (30) subjected to the earth's magnetic field, said sticking point being located in a portion (3) of the hollow rod between a first (H) and a second (B) point belonging to said rod, characterized in that it comprises the following consecutive stages involving:
continuously making, via the inside (2) of the hollow rod (1), a first measurement of the value of the magnetic field inside the portion (3) of the hollow rod having been magnetized by the earth's magnetic field, this first measurement being done by indexing it with respect to the distance from one of said first and second points,
applying a mechanical stress to said hollow rod at one of said first and second points (H, B),
continuously making, via the inside (2) of the hollow rod (1), a second measurement of the value of the magnetic field inside said portion (3) of the hollow rod, this second measurement being done by indexing it with respect to the distance from one of said first and second points, and
comparing the results (R1, R2) of the first and second measurements to determine the location of the sticking point (Pc) of the hollow rod between said first and second points, with respect to one of these two points.

2. Method per claim 1, characterized in that the mechanical stress is effectuated on said hollow rod at one of said first and second points (H, B) by one of the following two methods:
application of the mechanical stress prior to the stage of making the second continuous measurement of the value of the magnetic field inside said portion (3) of rod, and cancellation of said stress before taking this second measurement;
application of the mechanical stress prior to the stage of making the second continuous measurement of the value of the magnetic field inside said portion (3) of rod and maintaining of this stress while taking this second measurement.

3. Device per one of claims 1 and 2, characterized in that the mechanical stress applied to said hollow rod at one of the first and second points is one of the following mechanical forces: a torsion, a traction, a compression, a combination of a torsion and a traction, a combination of a torsion and a compression.

4. Device per one of claims 1 to 3, by way of application to the field of oil well drilling, when one uses a string of oil drilling rods made up from a plurality of rods joined to each other by screwing together at the level of the collars, and to carry out the unscrewing of the first collar located just above the sticking point (Pc), in order to recover the entire first portion of the string of rods situated above this first collar, characterized in that it furthermore consists of, in succession:
estimating the weight of the first portion of the rod string as a function of the weight and the length of each rod making up this first portion of the string of rods,
making a continuous third measurement of the value of the magnetic field via the inside (2) of the string of hollow rods (1) magnetized by the earth's magnetic field and on a portion of the string that includes at least the sticking point (Pc),
applying to the summit (S) of the string of rods emerging from the well a traction force essentially equal to the estimated weight of the first portion of the string of rods,
making a continuous fourth measurement of the value of the magnetic field via the inside (2) of the string of hollow rods (1) and on said portion of the string, then
comparing the results of the third and fourth measurement to determine, in relation to the sticking point (Pc), the place in the string of rods where the value of the magnetic field varies, and verifying whether this place is situated above the sticking point and at a distance less than the length of a rod making up the string of rods.

5. Device for implementing the method according to at least one of claims 1 to 3, characterized in that it contains:
a casing (10) of nonmagnetic material,
means (11) of moving the casing (10) inside (2) the hollow rod (1),
means (12) of indexing the position of the casing (10) with respect to the hollow rod (1) when it is moving between said first and second points (H, B), and
means (13), mounted in cooperation with the casing (10), to measure the magnetic field at each point of said hollow rod (1), and
means for processing the results of the measurements provided by the means (13) mounted in cooperation with the casing (10) to measure the magnetic field at each point of said hollow rod (1), so as to determine the location of the sticking point (Pc).

6. Device per claim 5, characterized in that the means (13) mounted in cooperation with the casing (10) to measure the magnetic field at each point of said hollow rod (1) are comprised of at least one magnetometer.

7. Device per claim 6, characterized in that the magnetometer is comprised of at least one of the following sensors: GMR sensor of brand name HONEYWELL series 1021 or 1022, GMR sensor of brand NVE Corporation series AAH002-02 or AAH004-00.

8. Device per one of claims 6 and 7, characterized in that it has a plurality of magnetometers distributed all around the casing (10) so that the set of all these magnetometers can analyze the entire periphery of the internal wall of the rods (1).
